(19) United States
(12) Patent Application Publication
(10) Pub. No.: US 2024/0200272 A1
(43) Pub. Date: Jun. 20, 2024

(54) MULTILAYER MATERIAL WHICH CAN BE USED AS PACKAGING, COMPRISING A LAYER OF CELLULOSIC MATERIAL AND A LAYER OF MATERIAL COMPRISING AT LEAST ONE CASEIN AND/OR AT LEAST ONE CASEINATE

(71) Applicant: LACTIPS, Saint-Paul-en-Jarez (FR)

(72) Inventors: Bastien BESSAIRE, Saint-Paul-en-Jarez (FR); Kheirdine MELLOUKI, Saint-Paul-en-Jarez (FR); Elodie CHEVALIER, Ternay (FR); Fannie CHIROUSSEL, Roche la Moliere (FR)

(73) Assignee: LACTIPS, Saint-Paul-en-Jarez (FR)

(21) Appl. No.: 18/572,985

(22) PCT Filed: Jun. 23, 2022
(86) PCT No.: PCT/FR2022/051226

§ 371 Date: Dec. 21, 2023

(30) Foreign Application Priority Data
Jun. 23, 2021 (FR) FR2106706

(51) Int. Cl. D21H 21/16; B65D 65/42; D21H 19/12; D21H 23/22; D21H 27/10

(52) U.S. Cl. CPC D21H 21/16; B65D 65/42; D21H 19/12; D21H 23/22; D21H 27/10

(57) ABSTRACT

A multilayer material including a layer of cellulosic material A and a layer of material B having at least one casein and/or at least one caseinate, water, and at least one plasticizer other than water, and, optionally gelatin. The invention also relates to the packaging made from this material, a product packaged with this packaging, and the manufacturing process of this material.

### TECHNICAL FIELD

The present disclosure relates to the field of multilayer materials that can be used as packaging. In particular, the present disclosure relates to a multilayer material comprising a layer of cellulosic material A and a layer of material B comprising at least one casein and/or at least one caseinate.

### PRIOR ART

The increasing scarcity in non-renewable resources, such as oil, and the increase in pollution in connection to these resources are leading to the development of less polluting and more environmentally friendly alternative solutions. In particular, with regard to packaging, the European Commission wants 100% of packaging to be reusable, mechanically recyclable or compostable by 2030 (Circular Economy Action Plan—2020).

In the food sector, the use of packagings made from potentially recyclable cellulosic materials, such as paper or cardboard packagings, is growing. However, there are still major obstacles to the recyclability of these packagings. Furthermore, the use of recycled paper in these packagings can also pose consumer safety problems.

Indeed, single-use packagings for takeaway dishes and fast food always have a plastic layer as an anti-grease barrier, generally made of polyamide (PA) or perfluoroalkyl substances (PFAS), for the convenience of consumers. This represents 65 k tons disposed of in Europe each year (amounting to 2025 million packaging units produced).

Furthermore, 17% of paper packagings are provided with a plastic layer, to provide a barrier to gases, grease or water (made of PE, PP, PET, PVDC, EVOH, or PVOH) to show the food inside, or to allow sealability (package closure).

In addition, recycled paper cannot be used in direct contact with food, due to the migration of mineral oils from the inks used in the previous paper, for example in newspapers. A layer of plastic must again be used as a barrier for consumer safety. This prevents widespread use of recycled paper in food packaging.

When this packaging is sorted, removing the plastic layer from the paper in recycling centers is a real problem which results at best in the loss of 10 to 20% of the paper fibers and at worst in polluting the fiber batches by plastics which must then be burned or buried.

### Technical Problem

It is therefore necessary to develop packagings that can overcome these disadvantages.

In this context, the present invention aims to satisfy at least one of the following objectives.

One of the objectives of the present invention is to provide a recyclable material which can be used as packaging.

One of the objectives of the present invention is to provide a bio-based recyclable material that can be used as packaging.

One of the objectives of the present invention is to provide of a recyclable material that can be used as packaging in the food sector.

One of the objectives of the present invention is to provide a biodegradable material which can be used as packaging.

Another objective of the present invention is to provide of a material based on cellulosic materials, having improved barrier properties.

One of the objectives of the present invention is to provide a recyclable material which can be easily produced.

### DISCLOSURE OF THE INVENTION

The present disclosure relates to a multilayer material comprising:
i) At least one layer of a cellulosic material A, and
ii) At least one layer of a material B comprising:
a. At least one casein and/or at least one caseinate;
b. Water, and
c. At least one plasticizer different from b).

The present disclosure also relates to a multilayer material obtained:
either by coating a layer of cellulosic material A with a solution S comprising:
a. At least one casein and/or at least one caseinate;
b. Water, and
c. At least one plasticizer different from b);
or by assembling a layer of cellulosic material A and a layer of material B comprising:
a. At least one casein and/or at least one caseinate;
b. Water, and
c. At least one plasticizer different from b), optionally by means of a binder, assembling being preferably carried out by complexing or laminating.

The present disclosure also relates to a packaging comprising a multilayer material.

The present disclosure also has as an object a product packaged by a packaging comprising a multilayer material.

The present disclosure also relates to a method for manufacturing a multilayer material, said method being carried out
either by coating a layer of cellulosic material A with a solution comprising:
a. At least one casein and/or at least one caseinate;
b. Water, and
c. At least one plasticizer different from b);
or by assembling a layer of cellulosic material A and a layer of material B comprising:
a. At least one casein and/or at least one caseinate;
b. Water, and
c. At least one plasticizer different from b), optionally by means of a binder, assembling being preferably carried out by complexing or laminating.

The inventors discovered that such a multilayer material could be used as packaging. Indeed, this multilayer material can be recycled in recycling centers without modifying lines or methods because the layer of material B is water-soluble. Recycling centers will be able to recover almost 100% of cellulosic material fibers through simple mechanical filtration. The residues of material B resulting from its solubilization will be biodegraded in the water treatment infrastructures already in place within the recycling plants. The fact that the residues of material B are biodegradable makes it possible to avoid pollution linked to microplastics.

In addition, the presence of a material B layer makes it possible to improve the barrier properties of the multilayer material, in particular the barrier properties to grease and oxygen, which makes it possible to consider use in the field of food packaging.

The multilayer material according to the invention also has good weldability properties, and in particular heat sealability properties.

Thus, the multilayer material according to the invention combines good recyclability, improved barrier properties and good weldability properties, which allows it to be used as packaging, particularly in the food field.

Furthermore, material B is safe for food contact, 100% renewable, compostable and biodegradable in the marine environment, which is not the case for most polymers used in packaging. Casein is an existing ingredient, documented in the food industry, and easily industrializable. The multilayer material can therefore be produced easily.

### DETAILED DESCRIPTION

Unless otherwise stated, throughout this document, % are expressed as % by weight.

By “packaging”, it is meant an object intended to contain and protect goods, to allow the handling and transport thereof from the producer to the consumer or to the user, and to enable the presentation thereof, the preservation thereof, the protection thereof and/or the use thereof.

By “cellulosic material”, it is meant, for example, a material which can be derived from a cellulose pulp. This cellulose pulp can be produced by chemical and/or mechanical processing, well known to the skilled person. This cellulose pulp can be derived from any suitable source such as wood, recycled wood, annual plants, agricultural residues (bagasse, straws, etc.), grasses (for example, sugar cane, bamboo) or cardboards.

By “thermoplastic”, it is meant, for example, a material which becomes malleable and foldable above a given temperature, the glass transition temperature Tg, but which becomes hard again below this Tg, these transformations being reversible.

By “biodegradable”, it is meant, for example, a material which can be decomposed under the action of micro-organisms (bacteria, fungi, algae, etc.). The result of this decomposition is the build-up of water, CO2 and/or methane, and possibly by-products (residues, new biomass) which are non-toxic for the environment. It is, for example, a biodegradable material according to the European standard EN NF 13432 and/or the NF T 51-800 standard.

By “between x and y”, it is meant, for example, that the bounds x and y are included in the interval [x, y].

By “water-soluble”, it is meant, for example, which dissolves in water. The water-solubility of a material can be measured as follows: a piece of a film (5 cm×5 cm, cut out using a die-cut form) is fixed on a photo slide holder then is immersed into a beaker having a 1000 ml capacity, containing 600 ml distilled water at 20° C. with stirring, with a magnetic bar, at 300 rpm. The time it takes for the film to bleed-through (in French: “se percer”) is measured. Disintegration of the film results in the formation of film particles. The test lasts 10 minutes after which the particles are passed through a 0.5 mm sieve in order to test the particle size. In the absence of particles in the sieve, the film is considered water soluble.

By “plasticizer”, it is meant, for example, a substance making it possible to lower the glass transition temperature Tg of the material.

By “hydrophobic”, it is meant, for example, a compound having little affinity with water and tending not to dissolve thereinto. Typically, it is a predominantly nonpolar compound.

By “hydrophilic”, it is meant, for example, a compound having an affinity with water and tending to dissolve thereinto. Typically, it is a compound having polar groups capable of forming hydrogen bonds.

By “surfactant”, it is meant, for example, an amphiphilic molecule, i.e., a molecule having both hydrophilic and hydrophobic properties.

By “HLB”, it is meant, for example, the hydrophilic-lipophilic balance. The HLB value can be calculated the following way: HLB=20×(Molar mass of the hydrophobic part)/(Molar mass of the molecule).

By “fatty acid”, it is meant, for example, an aliphatic monocarboxylic acid.

By “bio-based”, it is meant, for example, a product manufactured from materials of biological origin.

By “binder”, it is meant, for example, an agent making it possible to create a bonding layer between the cellulosic material A layer and the layer of material B. The binder used in the present invention can be a binder conventionally used in manufacturing multilayer materials and, in particular, multilayer films. Among the binders mention can be made of hot-melt glues (in French: “colles thermofusibles”).

### Multilayer Material

The invention firstly relates to a multilayer material comprising:
i) At least one layer of a cellulosic material A, and
ii) At least one layer of a material B comprising:
a. At least one casein and/or at least one caseinate;
b. Water, and
c. At least one plasticizer different from b).

The present disclosure also relates to a multilayer material obtained:
either by coating a layer of cellulosic material A with a solution comprising:
a. At least one casein and/or at least one caseinate;
b. Water, and
c. At least one plasticizer different from b);
or by assembling a layer of cellulosic material A and a layer of material B comprising:
a. At least one casein and/or at least one caseinate;
b. Water, and
c. At least one plasticizer different from b),
   optionally by means of a binder, assembling being preferably carried out by complexing or laminating.

The multilayer material is preferably recyclable and/or bio-based. The multilayer material can be recyclable according to Directive 2018/852/EU of May 30, 2018. According to an embodiment, the multilayer material is compostable, preferably according to NF T 51-800 standard.

The multilayer material can have a thickness of between 0.01 and 100 mm, preferably between 0.05 and 50 mm.

Cellulosic material A is preferably chosen from papers and cardboards. According to one embodiment, the cellulosic material A has a grammage of between 20 and 500 g/m2, preferably between 50 and 450 g/m2. According to one embodiment, the cellulosic material A is chosen from papers having a grammage of between 20 and 225 g/m2, and cardboards having a grammage of between 225 and 500 g/m2.

The layer of cellulosic material A can have a thickness of between 0.01 and 50 mm, preferably between 0.05 and 20 mm.

Cellulosic material A comprises cellulose, preferably at least 80% by weight, and preferably at least 90% by weight.

Cellulosic material A can be colored and include a pigment layer. Cellulosic material A may comprise a mineral layer, for example of the kaolin type.

Material B and/or solution S include:
a. At least one casein and/or at least one caseinate;
b. Water, and
c. At least one plasticizer different from b).

Casein is a protein from milk, poorly soluble in water. It is mainly obtained by precipitation by adding an acid (acid casein) or rennet (rennet casein) to milk, or by filtration (micellar casein). Casein consists of a mixture of α-casein, β-casein and K-casein having molar masses between 19,000 and 25,000 g/mol. By caseinate, it is meant, for example, a casein salt whose counter cation is chosen from the group comprising—preferably consisting of—calcium, potassium, ammonium, sodium and magnesium.

According to another embodiment, a) comprises at least one caseinate, for example a sodium caseinate, or a mixture of caseinates.

According to another embodiment, a) comprises a mixture of casein and at least one caseinate. In this case, the mass ratio between casein and caseinate(s) can be between 5/95 and 95/5, 20/80 and 80/20 or 40/60 and 60/40.

Material B and/or solution S may comprise gelatin d).

Gelatin is a protein that has a high level of glycine and proline. It is obtained by partial hydrolysis of collagen, mainly from collagen contained in animal skins and bones. It can be of type A (it then comes from processing collagen with an acid) or type B (it then comes from a processing collagen with a base). It can also be obtained by enzymatically processing collagen. The used gelatin has preferably not been chemically modified. According to an embodiment of the invention, the gelatin used is commercially available, or type B, food gelatin; it can be in the form of sheets, powder or granules. Advantageously, the used gelatin is of type B.

The ratio of the amounts a):d), when d) is included, can be between 90:10 and 20:80, preferably between 75:25 and 25:75, and preferably between 60:40 and 40:60. According to a particular embodiment, the ratio a):d) is 50:50. According to a particular embodiment, the ratio a):d) is between 55:45 and 45:55.

Plasticizer c) can be chosen from polyols, glycerol acetates, glycerol propionates and mixtures thereof.

As examples of polyols, mention may be made of glycerol, hexanetriol, glycols, including ethylene glycol, and sugars and derivatives thereof.

As examples of sugars, mention may be made of disaccharides, such as maltose, lactose, sucrose, and of monosaccharides such as fructose.

Among the sugar derivatives, mention may be made of their hydrogenated derivatives such as sorbitol, maltitol, mannitol, and xylitol, or even transformation products of these hydrogenated derivatives such as sorbitan.

According to an embodiment, plasticizer c) is chosen from glycerol, sorbitol, mannitol, ethylene glycol and mixtures thereof. Preferably, plasticizer c) is chosen from glycerol, sorbitol, and mixtures thereof. According to an embodiment, the plasticizer c) is glycerol.

Plasticizer c) may contain residual water.

Plasticizer c) makes it possible to lower the product viscosity by increasing the mobility of the molecular chains.

Advantageously, plasticizer c) is a hydrophilic plasticizer.

Material B and/or solution S may also comprise a hydrophobic agent e). The hydrophobic agent e) can be chosen from:
carboxylic polyacid esters;
C3-C33 carboxylic acids, preferably C4-C28 fatty acids, and even more preferably C6-C28 unsaturated fatty acids;
and mixtures thereof.

The carboxylic polyacid esters can be derived from at least one carboxylic polyacid and at least one alcohol, preferably a C1-C18 alcohol.

Among the carboxylic polyacids preferentially selected in the framework of the invention, mention may be made of citric acid, hydroxycitric acid, tartaric acid, malic acid, oxalic acid, malonic acid, succinic acid, glutaric acid, adipic acid, maleic acid, fumaric acid.

Among the preferred alcohols in accordance with the invention, mention may be made of C2-C6 alcohols, such as, for example, ethanol, n-propanol, iso-propanol, n-butanol and tert-butanol.

According to an embodiment, the hydrophobic agent e) is chosen from triethyl citrate, tributyl 0-acetyl citrate, tributyl citrate and mixtures thereof.

According to an embodiment, the hydrophobic agent e) is a C3-C33 carboxylic acid, preferably a C4-C28 fatty acid, and even more preferably an C6-C28 unsaturated fatty acid.

Among the C4-C28 fatty acids selected in the framework of the invention, mention may be made of caprylic acid, capric acid, lauric acid, myristic acid, palmitic acid, stearic acid, and mixtures thereof.

Among the particularly interesting C6-C28 unsaturated fatty acids, mention may be made of palmitoleic acid, oleic acid, linoleic acid, and mixtures thereof.

Material B and/or solution S may further comprise at least one surfactant f), preferably chosen from zwitterionic surfactants whose HLB is between 2 and 8.

Among the preferred surfactants, mention may be made of lecithin and/or the analogues thereof such as diacetylenic phosphonates, and polysorbates. Polysorbates are esters of fatty acids and polyoxyethylene sorbitan. Among the polysorbates, mention can be made of polysorbate 20, polysorbate 40, polysorbate 60, and polysorbate 80.

According to an embodiment, the ratio of the amounts of f) to e) is greater than or equal to 1. For example, this ratio can be between 1.3 and 3; preferably between 1.5 and 2.5.

Material B and/or solution S may also comprise a polysaccharide g). Preferably g) is chosen from pullulan, starch, alginates, and mixtures thereof. The polysaccharide g) can be a water-soluble polysaccharide.

Material B and/or solution S may further comprise a bittering agent h), preferably denatonium benzoate.

The bittering agent h) can be chosen from denatonium benzoate, denatonium benzoate derivatives, denatonium saccharide, denatonium chloride, sucrose benzoate, quinine, quinine hydrochloride, quinine sulfate, brucine, brucine sulfate, quassia, quassine, naringin, limonin, phenylthiocarbamide, quebracho, sucrose octaacetate, quercetin, berberine, and mixtures thereof.

According to an embodiment, material B and/or solution S also comprise an additive i) chosen from dyes, protein coagulants, anti-caking agents, glidants, and mixtures thereof. Among coagulants, mention may be made of citric acid and acetic acid. Among the anti-caking agents, mention may be made of colloidal silica. Among the glidants, mention may be made of polyethylene glycols and compounds with fatty chains, preferably C12-C28, having an amide end-group.

According to one embodiment, material B and/or solution S comprise an additive j) chosen from sequestering agents. By “sequestering agent”, it is meant, for example, ligands which form chemical complexes with metal ions such as copper, iron, nickel, calcium and magnesium. Among the sequestering agents, mention may be made of diammonium citrate, EDTA, phosphates, citric acid, pyrophosphates, and mixtures thereof.

The proportions of the different constituents of material B are expressed in % by weight relative to the total weight of material B at room temperature. According to an embodiment, material B comprises between 10 and 80% casein and/or caseinate a), preferably between 20 and 75%, and even more preferably between 25 and 70%.

According to an embodiment, material B comprises between 50 and 80% casein and/or caseinate a), preferably between 52 and 75%, and even more preferably between 55 and 70%. According to an embodiment, material B comprises between 10 and 55% casein and/or caseinate a), preferably between 20 and 50%, preferably between 25 and 40%, and even more preferably between 30 and 35%.

According to an embodiment, material B comprises between 1 and 55% gelatin d), preferably between 5 and 50%, preferably between 10 and 40%, and even more preferably between 30 and 35%.

According to a particular embodiment, material B comprises between 30 and 35% casein and/or caseinate a), and between 30 and 35% gelatin d).

Material B can comprise between 5 and 15% water b), preferably between 7 and 11%. The amount of water can be set between 9 and 10%. Water acts as a plasticizer which must be distinguished from the plasticizer c) entering into the composition of material B.

Material B can comprise c) between 10 and 35% of at least one plasticizer different from c), preferably between 15 and 30%.

Material B can comprise between 0.1 and 8% of a hydrophobic agent e), preferably between 1 and 4%. Advantageously, material B comprises between 0.5 and 6%, preferably between 1 and 3%, of a hydrophobic agent e).

Material B can comprise between 0.5 and 6% of at least one surfactant f), preferably chosen from zwitterionic surfactants whose HLB is between 2 and 8. Advantageously, the material B can comprise between 1 and 5% of at least one surfactant f), preferably between 1.5 and 4.5%, and even more preferably between 2 and 4%.

Material B may comprise between 2 and 10% of a polysaccharide g), g) being preferably chosen from pullulan, starch, alginates, and mixtures thereof. Advantageously, material B comprises between 4 and 8% of a polysaccharide g).

Material B can comprise between 0.001 and 0.5% of a bittering agent h), preferably denatonium benzoate. Advantageously, material B further comprises between 0.05 and 0.15% of a bittering agent h).

Material B can comprise between 0.1% and 5% of i). Material B can comprise between 1 and 5% of an additive j) chosen from sequestering agents.

Material B can be water-soluble and/or biodegradable. Material B can be bio-based. According to an embodiment, material B is a thermoplastic material. Material B can be obtained by extrusion, as mentioned in the examples.

According to an embodiment, the layer of material B is a film layer of material B, preferably a film layer of a thermoplastic, biodegradable and water-soluble material B. Typically, the film layer of material B has a thickness of between 1 and 150 microns, preferably between 2 and 50 microns and more preferably between 2.5 and 20 microns.

The proportions of the different constituents of the solution S are expressed in % by weight relative to the total weight of the dry matter in solution S. According to one embodiment, solution S comprises between 0.1 and 90% dry matter, preferably between 1 and 50% dry matter, preferably between 5 and 25% dry matter, and more preferably between 10 and 20% dry matter. Solution S can be obtained by solubilizing material B in water or by solubilizing the different components in water.

According to an embodiment, solution S comprises between 10 and 80% casein and/or caseinate a), preferably between 20 and 75%, and even more preferably between 25 and 70%.

According to an embodiment, solution S comprises between 50 and 80% casein and/or caseinate a), preferably between 52 and 75%, and even more preferably between 55 and 70%. According to an embodiment, solution S comprises between 10 and 55% casein and/or caseinate a), preferably between 20 and 50%, preferably between 25 and 40%, and even more preferably between 30 and 35%.

According to an embodiment, solution S comprises between 1 and 55% gelatin d), preferably between 5 and 50%, preferably between 10 and 40%, and even more preferably between 30 and 35%.

According to a particular embodiment, solution S comprises between 30 and 35% casein and/or caseinate a), and between 30 and 35% gelatin d).

Solution S can comprise c) between 10 and 35% of at least one plasticizer different from c), preferably between 15 and 30%.

Solution S can comprise between 0.1 and 8% of a hydrophobic agent e), preferably between 1 and 4%. Advantageously, solution S comprises between 0.5 and 6%, preferably between 1 and 3%, of a hydrophobic agent e).

Solution S can comprise between 0.5 and 6% of at least one surfactant f), preferably chosen from zwitterionic surfactants whose HLB is between 2 and 8. Advantageously, solution S may comprise between 1 and 5% of at least one surfactant f), preferably between 1.5 and 4.5%, and even more preferably between 2 and 4%.

Solution S may comprise between 2 and 10% of a polysaccharide g), g) being preferably chosen from pullulan, starch, alginates, and mixtures thereof. Advantageously, solution S comprises between 4 and 8% of a polysaccharide g).

Solution S may comprise between 0.001 and 0.5% of a bittering agent h), preferably denatonium benzoate. Advantageously, solution S also comprises between 0.05 and 0.15% of a bittering agent h).

Solution S can include between 0.1% and 5% of 1). Solution S can comprise between 1 and 5% of an additive j) chosen from sequestering agents.

Solution S may also contain a preservative and/or a biocide. The preservative agent and/or biocide concentration can be between 0.1 and 5%.

### Packaging Including a Multilayer Material

The present disclosure also relates to a packaging comprising a multilayer material. In some cases, the packaging includes layers other than the multilayer material, in other cases the packaging is made of the multilayer material.

The present disclosure also has as an object the use of a multilayer material for packaging various products (pharmaceuticals, food, chemicals, cosmetics, etc.).

The present disclosure also has as an object a product packaged by a packaging comprising a multilayer material.

The product can be in solid, liquid or gel form. The packaged product can be any object, for example it can be a mechanical part, a DIY object, a gardening object, a magazine, a newspaper, or disposable dishes.

The packaged product can for example be chosen from pharmaceutical, food, chemical, and cosmetic products.

According to one embodiment, the packaged product is a food product, such as for example meat, fish, vegetables, fruits, pastries, viennoiseries, chocolate, confectionery, food additives, ingredients, dry preparations, food powders, prepared meals.

According to an embodiment, the packaged product is a cosmetic product. According to an embodiment, the packaged product is a detergent.

Detergents can be in liquid form or powder form, compact or not. For example, it could be a detergent tablet. Among detergent tablets, mention may be made of dishwasher tablets and laundry detergent tablets. It can also be liquid detergent, such as liquid laundry detergent.

### Method for Manufacturing a Multilayer Material

The multilayer material can be manufactured by laminating, coating, sheet-pasting (in French: “contre-collage”), co-extrusion or extrusion coating (in French: “extrusion couchage”) methods well known to the skilled person.

The present disclosure also relates to a manufacturing method of a multilayer material, characterized in that it is carried out
either by coating a layer of cellulosic material A with a solution S comprising:
a. At least one casein and/or at least one caseinate;
b. Water, and
c. At least one plasticizer different from b);
or by assembling a layer of cellulosic material A and a layer of material B comprising:
a. At least one casein and/or at least one caseinate;
b. Water, and
c. At least one plasticizer different from b), optionally by means of a binder, assembling being preferably carried out by complexing or laminating.

According to an embodiment, manufacturing the multilayer material is performed by coating. In this case, the cellulosic material A layer is coated with a solution S. This can be done using application material (in French: “materiel de couchage”) well known to the skilled person. After coating, the coated cellulosic material A can be dried, for example in an oven, in order to obtain the multilayer material.

According to another embodiment, manufacturing the multilayer material is performed by assembling a layer of cellulosic material A and a layer of material B. In this case, assembling can be carried out by complexing or laminating.

Laminating can be carried out cold or hot. In the case of cold lamination, a binder can be used. In the case of hot lamination, this step can be carried out without a binder.

Complexation can be carried out by a laminating, co-extrusion or extrusion coating step, with or without a binder.

When a binder is used, assembling can for example be carried out by coating one of the faces of one of materials A or B with a binder, then by bringing the two materials into contact so that the binder finds itself between the two materials. Assembling can be carried out using a calender.

### Examples

In the examples below, two types of cellulosic materials (papers) were coated with a glycerol and sodium caseinate solution, prepared from thermoplastic granules, to prepare a multilayer material according to the invention. Unless otherwise stated, throughout this document, % are expressed as % by weight.

The cellulosic materials used are as follows:
Algro Sol PCC 90 g/m2 paper from Sappi, Kraft paper coated with kaolin on one side, Format 21*35 cm, coating on the shiny side,
Terrana 85 g/m2 paper from Gascogne Paper, natural kraft paper rubbed on one side, coating of the rubbed side, Format 21*35 cm

The thermoplastic granules used for coating were prepared by extrusion from sodium caseinate. The extruder used is a Clextral® BC 21 co-rotating twin-screw extruder, 25 mm in diameter, 21 mm center distance and 900 mm long. This extruder has at least 4 zones:
a first zone, for introduction,
a second zone, for introduction,
a third zone, for degassing, and
a fourth zone: a die.

The rotation speed of the twin-screws is between 175 and 320 rpm and the temperatures of the different zones are between 30 and 120° C. The first zone of the extruder is an introduction zone for powders: caseinate and lecithin. Liquids are introduced into the second zone. The extruder further includes an open-air degassing zone and a final zone consisting of a cylindrical rod die having a 4-mm diameter.

The screw profile is as follows: 750 mm direct pitch screw, 50 mm mixing screw, 100 mm reverse pitch screw.

At the extruder output, the rod is dried and introduced into a granulator to produce granules having a 2 to 3 mm diameter. The final composition of the granules is as follows:
63% sodium caseinate,
23.5% glycerol,
10% water,
2.3% soy lecithin, and
1.1% oleic acid.

### Paper Coating

Dissolution of the thermoplastic granules in water with stirring, to obtain a solution of 11%, 18% or 19% dry matter.

Coating the papers with the solution was performed with laboratory application (in French: “couchage”) equipment, an Elcometer which allows translating a threaded bar in order to spread and dose a solution on the surface of a paper. 2 coating passes on the same side of each of the papers were performed, in such a manner as to obtain a layer weight of 9 or 14 g/m2. The results obtained are shown in Table 1.

TABLE 1

| | | |
|---|---|---|
| TOTAL layer weight | Substrate | % DM Solution |

| | | | |
|---|---|---|---|
| 9 | g/m² | Gascogne | 11% |
| 14 | g/m² | Gascogne | 19% |
| 9 | g/m² | Sappi | 18% |
| 14 | g/m² | Sappi | 18% |

The coated paper sheets are then dried in an oven at 55° C. then under a half-moon dryer at 80° C. They are then placed under a heavy metal plate. Characterization of the obtained coated papers

### Physical Properties

### Grammage and Thickness

Characterizing substrate papers without coating and coated papers was performed under standardized conditions at 23° C.-50% RH (NF EN 20 187, 1993). The grammage measurement was performed according to the methodology described in standard NF EN ISO 536, 2012, and the thickness measurement according to the methodology described in standard NF EN ISO 534, 2011. The results obtained are in line with the expected values and correspond to the different deposits made onto the 2 papers.

### Adhesion Test FINAT Methodology

Good adhesion between the material B layer comprising sodium caseinate, and the paper A layer in cellulosic material is sought for.

The adhesion of the coated layer to the paper was tested using the Finat 1 methodology: To be able to perform the test in good conditions, a catch (in French: “amorce”) must be made on the samples, manually or with tape, in order to separate the coating from the substrate and thus peel off the layer. However, it was not possible to create this catch, the adhesion between the coated layer and the paper substrate being too strong.

Adhesion was then tested using the Finat 3 methodology: According to this methodology, the coated substrate is bonded by means of tape onto a plate. The specimens so prepared are made in compliance with the Finat 3 methodology, namely: holding the plate/tape/coated paper assembly under a pressure of 6.86 kPa (70 g/cm2) for 20 hours at 23° C. As in the Finat 1 methodology, no delamination between the coated layer and the paper substrate was observed. In fact, the delamination occurred at the level of the tape.

These tests show that the layer deposited on the surface adheres very well to the paper substrate, to such an extent that it is not possible to measure the peeling force. The adhesion of the coated layer to the different substrates is very good, whatever the weight of the deposited layer (9 or 14 g/m2).

### Barrier Properties

Grease Barriers: Cobb Index Measuring Methodology with Respect to Oil

Measuring the Cobb index is performed on a 25-cm2 surface and its duration is herein set to 60 sec. ISIO 4 oil colored with Sudan Red III is used, which allows for defects to be visualized when they exist. A methodology derived from the SCAN-P 37 standard is used. Measuring the Cobb index makes it possible to determine the oil amount that the surface of a piece of paper or cardboard can absorb over a specific period of time, here 60 s. A Cobb index as low as possible is desirable.

The measurements are carried out on 5 different samples. An average and the standard deviation are then calculated. Measurements are carried out at 23° C./50% RH after the samples have remained in these conditions for at least 12 hours. The results are shown in Table 2.

TABLE 2

| | Cobb | Standard | |
|---|---|---|---|
| Sample | Index | deviation | Observations |
| Gascogne Paper | 29.7 | 3.9 | Bleed-through |
| Gascogne Paper + | 1.1 | 0.6 | No coloring points |
| coating 9 g/m² | | | |
| Gascogne Paper + | 1.3 | 0.4 | No coloring points |
| coating 14 g/m² | | | |
| Sappi | 10.1 | 0.3 | Very light coloring |
| | | | spots |
| Sappi + coating 9 g/m² | 0.7 | 0.4 | No coloring points |
| Sappi + coating 14 g/m² | 0.8 | 0.2 | No coloring points |

These results show that the multilayer materials according to the invention have a much lower Cobb index than uncoated paper substrates, which reflects an improvement in the grease barrier properties.

### Oxygen Barrier: Characterization OTR Measurement at 23° C.-50% RH According to the ASTM F1927 Standard

The oxygen measurement is done using a Presens apparatus according to the ASTM F1927 standard. The measurement is performed at the temperature and humidity level of the conditioned room, i.e., 23° C./50% RH. The measurements were doubled on 4 different samples. The results are shown in Table 3.

TABLE 3

| Sample | Measured value |
|---|---|
| Gascogne Paper | >1,000,000 |
| Gascogne Paper + coating 9 g/m² | >30,000 |
| Gascogne Paper + coating 14 g/m² | >18,000 |
| Sappi | >25,000 |
| Sappi + coating 9 g/m² | 69/62 |
| Sappi + coating 14 g/m² | 0/0 |

These results show that the multilayer materials according to the invention have a much lower oxygen permeability than uncoated paper substrates, which reflects an improvement in the oxygen barrier properties.

### Recyclability of the Multilayer Materials According to the Invention

The recyclability of the multilayer materials according to the invention was determined. The recyclability of packaging is assessed within the meaning of Directive 2018/852/EU of May 30, 2018 (amending Directive 94/62/EC).

The recyclability of a packaging comes down to satisfying two criteria so that it can be recoverable in the recycling paper industry:
the packaging must have a cardboard-based structure comprising at least 50% by weight of paper-cardboard material, and
the packaging must be designed with materials or a combination of materials which are compatible with known, relevant and industrially available recycling technologies. It must not negatively affect recycling methods.

All multilayer materials prepared according to the invention contain at least 50% by weight of paper/cardboard material. The first condition is therefore fulfilled

A recycling test was then carried out with the multilayer materials prepared according to the invention in order to evaluate the impact of the presence of the layer of material B comprising sodium caseinate. The different steps as carried out are presented below.

### Pulping or Resuspension (ISO 5263-1* Standard)

The pulping operation consists in individualizing the cellulosic fibers so as to make the fibrous suspension pumpable with a view to screening it, using a laboratory pulper. For the purposes of the test and more particularly of the resuspension, the 60 g sample was torn into approximately 3×3-cm pieces in order to make it compatible with the size of the laboratory pulper. The prepared raw material is then resuspended under the following conditions:
Temperature*: 40° C.
Concentration: 3% (by weight)
Duration: 15 mins
Condition: neutral

These conditions are representative of the industrially applied conditions (* exception: temperature of 40° C. to simulate water temperatures in industrial recycling methods)

Observation of the Fibrous Suspension after Disintegration

After 15 minutes disintegration, the disintegrated raw material (called pulp or fibrous suspension) is observed visually in order to verify two points:
The fiber individualization indicating good defibration, and therefore sufficient pulping time. The 15 minutes can be extended if necessary
The color of the pulping waters to check whether or not the packaging has disgorged (color, ink and/or gloss).
   Screening or Elimination of Non-Fibrous Unwanted Matters (TAPPI-ANSI T275 sp-18 Standard):

The pulp corresponding to the disintegration of the sample to be tested is then collected and further screened on two cascaded Somerville laboratory screening devices, the first is equipped with a 15/100-mm slotted sieve and the second with a 10/100-mm sieve. The admitted pulp passes through the slots of the screeners while the undesirable elements (such as plastic pieces) remain on the surface of the screening sieve. The first screener makes it possible to retain large contaminants and the second one any residual contaminants.

### Appearance Handsheet

At the output of the pulping and 10/100 mm screening steps, laboratory sheets (called handsheets) are made according to the Rapid-Kothen methodology (Standard ISO 5269-2:2004 Pulps—Preparation of laboratory sheets)

The results obtained are shown in table 4 below

TABLE 4

| | | | | | | |
|---|---|---|---|---|---|---|
| | | Sappi | Sappi | | Gascogne | Gascogne |
| | | Paper + | Paper + | | Paper + | Paper + |
| | Sappi | coating | coating | Gascogne | coating | coating |
| Sample | Paper | 9 g/m² | 14 g/m² | Paper | 9 g/m² | 14 g/m² |

Pulping step

| | | | | | | |
|---|---|---|---|---|---|---|
| Pulping time | 15 mins | 15 mins | 15 mins | 15 mins | 15 mins | 15 mins |
| Appearance | Visual | Visual | Visual | Visual | Visual | Visual |
| handsheets | appearance | appearance | appearance | appearance | appearance | appearance |
| | ok | ok | ok | ok | ok | ok |
| Color of the | OK | OK | OK | OK | OK | OK |
| waters | | | | | | |

Screening step

| | | | | | | |
|---|---|---|---|---|---|---|
| Rejections, | 2.932 g | 3.316 g | 4.060 g | 0.209 g | 0.092 g | 0.140 g |
| 15/100 | 5.20% | 5.88% | 7.20% | 0.16% | 0.37% | 0.25% |
| Rejections, | 0.846 g | 0.837 g | 0.760 g | 2.205 g | 4.616 g | 6.060 g |
| 10/100 | 1.58% | 1.58% | 1.45% | 3.92% | 8.21% | 10.77% |
| Sticks to the | No | No | No | No | No | No |
| 0.15 mm grid | | | | | | |
| Sticks to the | No | No | No | No | No | No |
| 0.10 mm grid | | | | | | |
| Appearance | Visual | Visual | Visual | Visual | Visual | Visual |
| handsheets | appearance | appearance | appearance | appearance | appearance | appearance |
| (output of | ok | ok | ok | ok | ok | ok |
| Sommerville | | | | | | |
| 10/100 mm) | | | | | | |
| Recyclability | OK | OK | OK | OK | OK | OK |

These results show:
that good fiber individualization is achieved during pulping
that appropriate rejection rates are obtained during screening; these rates are acceptable with respect to recyclability.
that the handsheets at the output of the pulper or of the screening have a fully satisfactory visual appearance.

These results show that the multilayer materials according to the invention meet well the different recyclability criteria of packaging within the meaning of Directive 2018/852/EU of May 30, 2018.

The presence of the layer of material B comprising glycerol and sodium caseinate, on a layer A of cellulosic material does not affect the recyclability of this cellulosic material.

### Heat Sealability of Multilayer Materials According to the Invention

A multilayer material was prepared according to the procedure described above. The layer weight is 10 g/m2. Heat sealability tests were performed on a Lako Seal Tester SL10 device from Lako Sool with the following parameters:
Pressure: 0.2N/mm²
Contact time: 0.5 s
Temperature: between 150 and 170° C.
   The dimension of the heat-sealed specimens was 20 mm*25.4 mm.

After sealing the specimens, packing for 24 hours at 23° C. and 50% RH was performed. Peeling tests according to standard ASTM F88, in a not held T shape were then carried out. 3 peeling tests were carried out for each of the selected sealing conditions.
Width of the samples: 25 mm
Peeling distance: =20 mm, i.e., the sealing distance
Peeling speed: 300 mm/min.

The results obtained are shown in Table 4 below.

TABLE 5

| Sealing temperature | 150° C. | 160° C. | 170° C. |
|---|---|---|---|
| Type of failure when peeling off | Cohesive | Cohesive | Cohesive |
| Average peeling forces from the | 154 | 168 | 157 |
| plate, N/m | (10.0) | (15.1) | (16.0) |
| (standard deviation) | | | |

These results show that the multilayer material according to the invention has good weldability. Indeed, the fact of having a cohesive failure indicates that the failure occurs in the material and not at the seal. Furthermore, the peeling forces for the sealings carried out at 150° C., 160° C. or 170° C. are similar and high. Thus, the multilayer materials according to the invention have good heat-sealing properties.

1. A multilayer material including:
i) at least one layer of a cellulosic material A, and
ii) a least one layer of a material B comprising:
a. at least one casein and/or at least one caseinate;
b. water, and
c. at least one plasticizer different from b).

2. The multilayer material according to claim 1, wherein material B further comprises gelatin d).

3. The multilayer material according to claim 1, material B also comprises a hydrophobic agent e), chosen from:
carboxylic polyacid esters;
C3-C33 carboxylic acids;
and mixtures thereof.

4. The multilayer material according to claim 1, wherein material B further comprises at least one surfactant f).

5. The multilayer material according to claim 1, wherein the plasticizer c) of material B is chosen from polyols, glycerol acetates, glycerol propionates, and mixtures thereof.

6. The multilayer material according to claim 1, wherein material B comprises between 10 and 80% casein and/or caseinate a).

7. The multilayer material according to claim 1, wherein the cellulosic material A is chosen from papers and cardboards.

8. The multilayer material according to claim 1, wherein the layer of material B is a film layer of material B.

9. An obtained multilayer material:
either by coating a layer of cellulosic material A with a solution S comprising:
a. at least one casein and/or at least one caseinate;
b. water, and
c. at least one plasticizer different from b);
or by assembling a layer of cellulosic material A and a layer of material B comprising:
a. at least one casein and/or at least one caseinate;
b. water, and
c. at least one plasticizer different from b),
optionally by means of a binder, assembling being carried out by complexing or laminating.

10. Packaging wherein comprises a multilayer material according to claim 1.

11. A product wherein hit is packaged with packaging according to claim 10.

12. The product according to claim 11, wherein it is a food product.

13. A method for manufacturing a multilayer material, wherein it is carried out
either by coating a layer of cellulosic material A with a solution S comprising:
a. at least one casein and/or at least one caseinate;
b. water, and
c. at least one plasticizer different from b);
or by assembling a layer of cellulosic material A and a layer of material B comprising:
a. at least one casein and/or at least one caseinate;
b. water, and
c. at least one plasticizer different from b),
optionally by means of a binder, assembling being carried out by complexing or laminating.
